(19) United States
(12) Patent Application Publication
(10) Pub. No.: US 2016/0180573 A1
(43) Pub. Date: Jun. 23, 2016

(54) GAME ENGINE FOR ANALYTICAL GRAPHIC REPRESENTATIONS

(71) Applicants: Nikita Jain, Bangalore (IN); Devicharan Vinnakota, Bangalore (IN)

(72) Inventors: Nikita Jain, Bangalore (IN); Devicharan Vinnakota, Bangalore (IN)

(21) Appl. No.: 14/575,414

(22) Filed: Dec. 18, 2014

(51) Int. Cl. G06T 15/00; G06T 11/00; G06T 1/60; G06Q 10/06

(52) U.S. Cl. CPC G06T 15/005; G06Q 10/067; G06T 11/00; G06T 1/60

(57) ABSTRACT

The present disclosure involves systems, software, and computer implemented methods for rendering interactive analytical graphic representations using a game engine. A set of processed data is received from an analytical system. The set of processed data is stored in a first format. The set of processed data comprises raw analytical data that are processed by an analytical application. The set of processed data is adapted into a set of game data. The set of game data is stored in a second format. An interactive analytical graphic representation is rendered based on the set of game data. The set of game data is stored for replay analytics.

### TECHNICAL FIELD

The present disclosure relates to computer systems and computer-implemented methods for rendering interactive analytical graphic representations using a game engine.

Business analysis is an important aspect for any business and company. In today's competitive market, a business cannot go without understanding its customers as well as all the facets of its business processes. Users typically rely on business analytical tools to evaluate and analyze a business process. In some cases, business analytical tools process raw analytical data of a business process and present the processed analytical data to the users.

### SUMMARY

The present disclosure involves systems, software, and computer-implemented methods for rendering interactive analytical graphic representations using a game engine. One computer-implemented method includes receiving, from an analytical system, a set of processed data, wherein the set of processed data is stored in a first format, wherein the set of processed data comprises raw analytical data that are processed by an analytical application; adapting the set of processed data into a set of game data, wherein the set of game data is stored in a second format; rendering an interactive analytical graphic representation based on the set of game data; and storing the set of game data for replay analytics.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising: receiving a replay command; identifying, in response to receiving the replay command, the stored set of game data; retrieving the stored set of game data; and rendering a replay interactive analytical graphic representation based on the stored set of game data.

A second aspect, combinable with any of the previous aspects, further comprising: receiving a rendering command; generating a request for game data; translating the request for game data into a query for processed data; transmitting, to the analytical system, the query for processed data; and receiving, in response to the query, a set of queried processed data.

A third aspect, combinable with any of the previous aspects, wherein the first interactive analytical graphic representation is a 3-Dimensional (3D) or a 2-Dimensional (2D) image.

A fourth aspect, combinable with any of the previous aspects, wherein the raw analytical data comprises business analytical data.

A fifth aspect, combinable with any of the previous aspects, wherein the interactive analytical graphic representation is presented at an analytical client, wherein the analytical client presents the interactive analytical graphic representation in a web browser.

A sixth aspect, combinable with any of the previous aspects, wherein the rendering is performed by a game engine that uses Web Graphics Library (WebGL).

A seventh aspect, combinable with any of the previous aspects, wherein the rendering is performed by a game engine in an analytical container.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for rendering interactive analytical graphic representations using a game engine.

FIGS. 2A and 2B are a combined swim-lane diagram illustrating example operations related to actions for rendering interactive analytical graphic representations using a game engine.

FIG. 3 is a flowchart of an example operation related to translating a request for game data into a query for processed data.

FIG. 4 is a flowchart of an example operation related to rendering an interactive analytical graphic representation.

FIG. 5 is a flowchart of an example operation related to replaying an interactive analytical graphic representation.

FIG. 6 is a block diagram of an exemplary computer used to render interactive analytical graphic representations using a game engine.

### DETAILED DESCRIPTION

The present disclosure describes a system that can render interactive analytical graphic representations using a game engine. The system embeds a game engine inside a business analytical tool. The game engine enables the business analytical tool to render interactive analytical graphic representations based on analytic data. The game engine also provides replay analytics inside the business analytical tool.

From a user's perspective, the user can send a rendering command to the business analytical tool for an interactive analytical graphic representation of a business process. The rendering command may initiate a rendering operation performed by a game engine in the business analytical tool. The business analytical tool may process raw analytical data related to the business process and adapt the processed data into game data. The game engine may render an interactive analytical graphic representation based on the adapted game data. The interactive analytical graphic representation may be in the form of a 2-Dimensional or a 3-Dimensional image. The interactive analytical graphic representation may also be animated. The user may analyze the business process by interactive operations. For example, the user may pause, resume, or replay the interactive analytical graphic representation. In addition, the game engine may provide other functionalities for users to analyze the business process. For example, these functionalities may include sound, crash detection, streaming, and memory management.

In general, the present disclosure describes a system capable of providing a simpler and easier solution to users performing business analytics by providing interactive analytical graphic representations based on analytical data. For example, traditional business integration tools use static charts and objects to represent the data in a stagnant fashion. They do not show how objects behaved in a specific scenario. Nor do they support replay functionalities, which allow the users to perform replay analytics for fast data analysis and immediate problem corrections. In contrast, the interactive analytical graphic representations may provide a dynamic presentation of a business process. The interactive analytical graphic representation may also provide 2-Dimensional or 3-Dimensional images for the analytics. Furthermore, the interactive analytical graphic representations may provide capabilities for users to perform interactive operations, e.g., pause, resume, and replay a business process. Moreover, the interactive analytical graphic representations that are rendered by the game engine are driven by the underlying analytical data, and therefore may not need continuous user assistance or interaction.

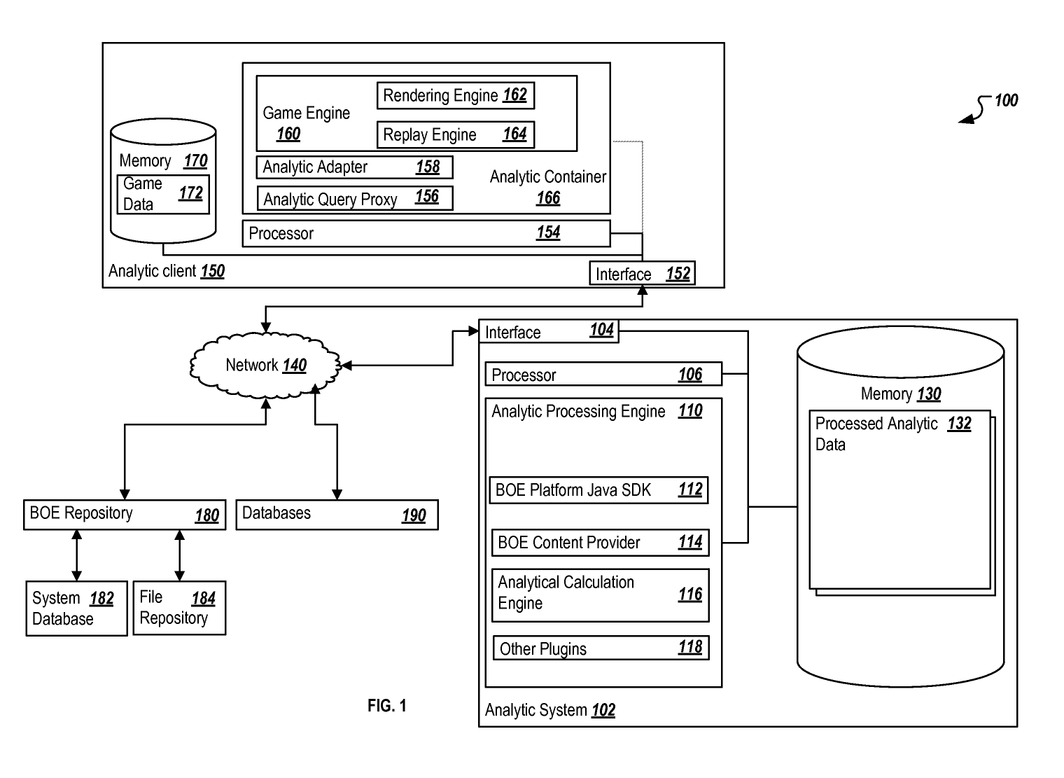

Turning to the illustrated embodiment, FIG. 1 is a block diagram illustrating an example system 100 for rendering interactive analytical graphic representations using a game engine. As illustrated in FIG. 1, system 100 is a client-server system capable of processing raw analytical data, rendering interactive analytical graphic representations using a game engine based on processed analytical data, storing game data used by the game engine, and replaying interactive analytical graphic representations. Specifically, illustrated system 100 includes an analytic client 150, an analytic system 102, a network 140, databases 190, and a Business Object Enterprise (BOE) repository 180 that is communicably coupled with a system database 182 and a file repository 184. Although components are shown individually, in some implementations, functionality of two or more components, systems, or servers may be provided by a single component, system, or server. Similarly, in some implementations, the functionality of one illustrated component, system, or server may be provided by multiple components, systems, servers, or combinations thereof. Conversely, multiple components may be combined into a single component, system, or server, where appropriate.

As used in the present disclosure, the term “computer” is intended to encompass any suitable processing device. For example, the analytic system 102 may be any computer or processing device such as, for example, a blade server, general-purpose personal computer (PC), Mac®, workstation, UNIX-based workstation, or any other suitable device. Moreover, although FIG. 1 illustrates one analytic system 102, the analytic system 102 can be implemented using two or more systems, as well as computers other than servers, including a server pool. In other words, the present disclosure contemplates computers other than general purpose computers, as well as computers without conventional operating systems. Further, illustrated analytic client 150 and analytic system 102 may each be adapted to execute any operating system, including Linux, UNIX, Windows, Mac OS®, Java™, Android™, or iOS. According to one implementation, the illustrated systems may also include or be communicably coupled with a communication server, an e-mail server, a web server, a caching server, a streaming data server, and/or another suitable server or computer.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

In general, the analytic client 150 represents an application, set of applications, software, software modules, or combination of software and hardware that render interactive analytic graphic representations. In some cases, the analytic client 150 may be located at a client site that is communicably coupled with the analytic system 102. In some case, the analytic client 150 may be co-located with the analytic system 102 or is part of the analytic system 102. Examples of the analytic client 150 include a computer, a mobile device, a terminal, and other devices that may host the analytic client program.

As illustrated, the analytic client 150 includes an interface 152, a processor 154, an analytical container 166, and a memory 170. In general, the analytic client 150 is a simplified representation of one or more systems and/or servers that provide the described functionality, and is not meant to be limiting, but rather an example of the systems possible.

The interface 152 is used by the analytic client 150 for communicating with other systems in a distributed environment—including within the system 100—connected to the network 140, e.g. the analytic system 102. Generally, the interface 152 comprises logic encoded in software and/or hardware in a suitable combination and operable to communicate with the network 140. More specifically, the interface 152 may comprise software supporting one or more communication protocols associated with communications such that the network 140 or interface's hardware is operable to communicate physical signals within and outside of the illustrated system 100.

As illustrated in FIG. 1, the analytic client 150 includes a processor 154. Although illustrated as a single processor 154 in FIG. 1, two or more processors may be used according to particular needs, desires, or particular implementations of the system 100. Each processor 154 may be a central processing unit (CPU), an application specific integrated circuit (ASIC), a field-programmable gate array (FPGA), or another suitable component. Generally, the processor 154 executes instructions and manipulates data to perform the operations of the analytic client 150. Specifically, the processor 154 executes the algorithms and operations described in the illustrated figures, including the operations performing the functionality associated with the analytic client 150 generally, as well as the various software modules, including the functionality for sending communications to and receiving transmissions from the analytic system 102.

As illustrated in FIG. 1, the analytic client 150 includes an analytical container 166. The analytic container 166 may be a plugin for a web browser, a mobile application, or any other software that render interactive analytic graphic representations based on analytical data. The analytical data may be related to a business process. Therefore the analytic container 166 may be used to render interactive analytic graphic representations and replay analytics in a business analytical tool to analyze the business process. However, the analytic container 166 may, in some implementations, be integrated in other analytical tools. For example, the analytic container 166 may be used to render interactive analytic graphic representations and provide replay analytics based on analytical data in other domains, e.g., medical, sports, or transportation.

The illustrated analytic container 166 can generate queries for processed analytical data to the analytic system 102, where the analytic system 102 processes raw analytical data and generates processed analytical data. The illustrated analytic container 166 can also receive processed analytical data 132 from the analytic system 102. In some cases, the processed analytical data 132 is stored in a format that is used by the analytic system 102. The analytic container 166 has, or is associated with, functionality for adapting the processed data into a set of game data that is stored in a different format. In some cases, the game data is stored in a format that is used by a game engine to render interactive analytic graphic representation. The analytic container 166 may also be associated with the functionality to store the game data for replay analytics.

As illustrated, the analytical container 166 includes an analytical query proxy 156, an analytic adapter 158, and a game engine 160. In general, the analytical container 166 is a simplified representation of one or more systems and/or servers that provide the described functionality, and is not meant to be limiting, but rather an example of the systems possible

As illustrated, the analytical container 166 includes the analytic query proxy 156. The analytic query proxy 156 represents an application, set of applications, software, software modules, or combination of software and hardware that generate a query for related processed analytic data to the analytic system 102. The query may be formatted based on the communication path between the analytical container 166 and the analytic system 102. For example, the analytic system 102 and the analytical container 166 may be communicably coupled based on an HTTP protocol. In such a case, the query may be formatted according to an HTTP protocol. Further, the query may be constructed based on the input configuration of the analytic system 102. For example, if the analytic system 102 uses SAP's Lumira desktop plugins to process analytical data, the query may be constructed based on Lumira protocols.

As illustrated, the analytical container 166 also includes the analytic adapter 158. The analytic adapter 158 represents an application, set of applications, software, software modules, or combination of software and hardware that adapts the processed analytical data into game data. In some implementations, the processed analytical data 132 is stored in a format that is used by the analytic system 102. For example, if the analytic system 102 uses Lumira desktop plugins to process analytical data, the processed analytical data may be stored in a Lumira format. The game data is stored in a format that is used by the game engine 160. Typically, the format that is used to store the game data is different than the format that is used to store processed data. In some cases, any number of dimensions can be added to the processed data during the adaption to arrange the game data to be suitable to rendering in multiple dimensions. Using the analytical adapter 158 in the analytical container 166 to adapt the processed data can shield the rendering operation from the analytic system 102. This approach enables the processed analytic data to be passed to the game engine 160 in a non-intrusive way and thereby minimize changes on existing analytic systems that process analytic data. Following represents an example of game data.

[

{

“playerName”: “player1”,
“team”: “team1”,
“timestamp”: 123,
“XYPlot”: [

“x”,
“y”

],
“actionmetadata”: {

“leftHandPos”: [

“x”,
“y”,
“scaleX”,
“scaleY”,
“rotation”,
“width”,
“height”

],
“rightHandPos”: [

“x”,
“y”,
“scaleX”,
“scaleY”,
“rotation”,
“width”,
“height”

],
“leftLegPos”: [

“x”,
“y”,
“scaleX”,
“scaleY”,
“rotation”,
“width”,
“height”

],
“rightLegPos”: [

“x”,
“y”,
“scaleX”,
“scaleY”,
“rotation”,
“width”,
“height”

]

}

},
{

“playerName”: “player2”,
“team”: “team1”,
“timestamp”: 123,
“XYPlot”: [

“x”,
“y”

],
“actionmetadata”: {

“leftHandPos”: [

“x”,
“y”,
“scaleX”,
“scaleY”,
“rotation”,
“width”,
“height”

],
“rightHandPos”: [

“x”,
“y”,
“scaleX”,
“scaleY”,
“rotation”,
“width”,
“height”

],
“leftLegPos”: [

“x”,
“y”,
“scaleX”,
“scaleY”,
“rotation”,
“width”,
“height”

],
“rightLegPos”: [

“x”,
“y”,
“scaleX”,
“scaleY”,
“rotation”,
“width”,
“height”

]

}

}

]
]

As illustrated, the analytical container 166 also includes the game engine 160. The illustrated game engine 160 represents an application, set of applications, software, software modules, or combination of software and hardware that render interactive analytic graphic representations. The game engine 160 may also provide sound, crash detection, streaming, memory management, or any other functionalities for the rendering operation. The game engine 160 may render an interactive analytic graphic representation based on the adapted game data. For example, the game data may be adapted from processed analytic data that represents a business process that includes more than one operation, such as purchasing, producing, marketing, and selling operations. The game engine 160 may render an interactive analytic graphic representation that presents these different operations in successive stages. The interactive analytic graphic representation may include dynamic animations instead of or in addition to static graphs. In such a case, the dynamic movements of the interactive analytical graphic representation are driven by the underlying analytic data, without continuous user assistance or interaction. As discussed above, the game engine 160 may also render interactive analytic graphic representations based on analytic data in domains other than business analytics. For example, the game engine 160 may also render interactive analytic graphic representations based on medical, sports, or transport analytical data.

As illustrated, the game engine 160 includes a rendering engine 162 and a replay engine 164. The illustrated rendering engine 162 represents an application, set of applications, software, software modules, or combination of software and hardware that render graphic images based on game data. The rendering engine 162 processes game data and draws visual objects on a user interface. In some implementations, the user interface is a web browser. In some cases, the rendering engine 162 draws visual images as soon as it receives game data. In some implementations, the rendering engine 162 may be a pluggable software that caters to different domains of analytical data, e.g., business, medical, sports, or transport. In some cases, the rendering engine 162 may draw 2-Dimensional images or 3-Dimensional images.

The illustrated replay engine 164 represents an application, set of applications, software, software modules, or combination of software and hardware that replay interactive analytic graphic representations. In some implementations, the replay engine 164 stores the game data that is associated with an interactive analytical graphic representation for replay analytics. The replay engine 164 may store the game data locally in the analytic client 150, e.g., in memory 170.

In some implementations, the replay engine 164 may include a parsing logic that is used to parse the game data into different components. For example, the game data may be associated with an interactive analytical representation of a business process. The business process may include more than one operation, such as purchasing, producing, marketing, and selling operations. The parsing logic may parse the game data into subsets that are associated with each operation. In another example, the parsing logic may parse the game data into subsets that are associated with different business entities, e.g., the buyer, the seller, or the transporter, in the business process. In some implementations, the replay engine 164 may include one or more filters that filters the game data into different subsets. For example, each subset may correspond to a time period within the business process. In another example, each subset may correspond to a different analytical granularity of the business process. In some implementations, the replay engine 164 may select one or more subsets of game data to store in the memory 170 instead of storing the entire set of game data related to the interactive analytical graphic representations. In some cases, the replay engine 164 may alter the game data that may benefit the user to do a better analysis and store the altered game data in the memory 170. In some cases, the replay engine 164 may perform the parsing, the filtering, the selecting, or the altering operation based on predetermined parameters, which are abstracted from the user. Alternatively or in combination, the replay engine 164 may perform the parsing, the filtering, the selecting, or the altering operation based on parameters selected by the user. When the game engine 160 receives a replay command to replay an interactive analytic graphic representation, the replay engine 164 may retrieve the stored game data from the memory 170. The replay engine 164 may send the retrieved game data to the rendering engine to render a replay interactive analytic graphic representation.

The analytic client 150 also includes memory 170, or multiple memories 170. The memory 170 may include any memory or database module and may take the form of volatile or non-volatile memory including, without limitation, magnetic media, optical media, random access memory (RAM), read-only memory (ROM), removable media, or any other suitable local or remote memory component. The memory 170 may store various objects or data, including financial data, user information, administrative settings, password information, caches, applications, backup data, repositories storing business and/or dynamic information, and any other appropriate information including any parameters, variables, algorithms, instructions, rules, constraints, or references thereto associated with the purposes of the analytic client 150. As illustrated, the memory 170 can store a set of game data 172 that is associated with an interactive analytical graphic representation. Storing the game data locally in the memory 170 enables the game engine 160 to provide replay analytics in real time. This approach provides the user a solution to interact with a visualization of a business analysis. Additionally, the memory 170 may store any other appropriate data, such as VPN applications, firmware logs and policies, firewall policies, a security or access log, print or other reporting files, as well as others.

In general, the analytic system 102 represents an application, set of applications, software, software modules, or combination of software and hardware that processes raw analytical data. In some cases, the analytic client 150 may be implemented in the analytic system 102. The analytic system 102 illustrated herein is described in terms of processing raw analytical data. The raw analytical data may be related to a business process. However, the analytic system 102 may, in some implementations, process analytical data in other domains, e.g., medical, sports, or transportation.

The illustrated analytic system 102 can receive queries for processed analytical data and provide processed analytical data in response. The illustrated analytic system 102 can also request and receive raw analytical data from the BOE repository 180 or the databases 190. Further, the illustrated analytic system 102 can process the raw analytical data and generate processed analytic data. In some cases, the raw analytic data represents analytical information artifacts related to a process that is collected in its raw format. For example, in a business process related to a life cycle of a product, the raw analytical data may include the cost of the materials, the cost of labor, the cost of shipping, the cost of marketing, the date of acquiring the material, the date of production, the date of shipping, the date of sale, etc. The analytic system 102 may process the raw analytical data and generate processed data that can be presented for business analysis. For example, the processed data may represent the profit margin of the product calculated based on various costs, the length of inventory held in different business process nodes, the production efficiency of a business node, and others. Further, as described before, the analytic system 102 may process data in other domain. For example, the raw analytic data may represent raw data collected in a transport process, which may include the coordinates of trucks at different times. The analytic system 102 may process the raw analytic data and generate processed data. The processed data may include the speed of each truck, the average delivery time between different locations, different trucks, and different drivers.

The illustrated analytic system 102 includes an interface 104, a processor 106, an analytic processing engine 110, and a memory 130. In general, the analytic system 102 is a simplified representation of one or more systems and/or servers that provide the described functionality, and is not meant to be limiting, but rather an example of the systems possible.

The interface 104 is used by the analytic system 102 for communicating with other systems in a distributed environment—including within the system 100—connected to the network 140, e.g., the analytic client 150, the BOE repository 180, and the databases 190. Generally, the interface 104 comprises logic encoded in software and/or hardware in a suitable combination and operable to communicate with the network 140. More specifically, the interface 104 may comprise software supporting one or more communication protocols associated with communications such that the network 140 or interface's hardware is operable to communicate physical signals within and outside of the illustrated system 100.

As illustrated in FIG. 1, the analytic system 102 includes a processor 106. Although illustrated as a single processor 106 in FIG. 1, two or more processors may be used according to particular needs, desires, or particular implementations of the system 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the analytic system 102. Specifically, the processor 106 executes the algorithms and operations described in the illustrated figures, including the operations performing the functionality associated with the analytic system 102, generally, as well as the various software modules, including the functionality for sending communications to and receiving transmissions from the analytic client 150, the BOE repository 180, and the databases 190.

As illustrated, the analytic system 102 also includes the analytic processing engine 110. The analytic processing engine 110 represents an application, set of applications, software, software modules, or combination of software and hardware that process raw analytic data to generate processed analytic data. In some implementations, the analytic processing engine 110 may be implemented as Lumira desktop plugins. The analytic processing engine 110 also receives queries from analytic client 150 and sends queried processed data in response. If the queried processed data relates to raw analytic data that is not stored in the analytic system 102, the analytic processing engine 110 may also generate requests to the BOE repository 180 and the databases 190 to request the raw analytic data.

As illustrated, the analytic processing engine 110 includes a BOE platform Java SDK 112, a BOE content provider 114, an analytical calculation engine 116, and other plugins 118. In general, the analytic processing engine 110 is a simplified representation of one or more systems and/or servers that provide the described functionality, and is not meant to be limiting, but rather an example of the systems possible.

The BOE platform Java SDK 112 and the BOE content provider 114 represents an application, set of applications, software, software modules, or combination of software and hardware that communicate the BOE repository 180 over a corba layer interface. The BOE platform Java SDK 112 and the BOE content provider 114 may generate requests for raw analytic data to the BOE repository 180 and provide the retrieved raw analytic data to the analytical calculation engine 116 for processing.

The illustrated analytical calculation engine 116 represents an application, set of applications, software, software modules, or combination of software and hardware that processes raw analytical data. In some cases, the analytical calculation engine 116 also communicates to the databases 190 by generating requests for raw analytical data stored in the databases 190 and receive raw analytical from the databases 190.

The illustrated other plugins 118 represents an application, set of applications, software, software modules, or combination of software that can be included in the analytic processing engine 110

The analytic system 102 also includes memory 130, or multiple memories 130. The memory 130 may include any memory or database module and may take the form of volatile or non-volatile memory including, without limitation, magnetic media, optical media, random access memory (RAM), read-only memory (ROM), removable media, or any other suitable local or remote memory component. The memory 130 may store various objects or data, including financial data, user information, administrative settings, password information, caches, applications, backup data, repositories storing business and/or dynamic information, and any other appropriate information including any parameters, variables, algorithms, instructions, rules, constraints, or references thereto associated with the purposes of the analytic system 102. As illustrated, the memory 130 can store a set of processed analytic data 132, which may be sent to the analytic client 150 in response to a query. Additionally, the memory 130 may store any other appropriate data, such as VPN applications, firmware logs and policies, firewall policies, a security or access log, print or other reporting files, as well as others.

Network 140 facilitates wireless or wireline communications between the components of the system 100 (e.g., between the analytic system 102 and the analytic client 150, between the analytic system 102 and the BOE repository 180 and databases 190, among others), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components may be included within network 140 as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n, 802.20, WiMax, LTE, and/or any other appropriate wireless link. In other words, the network 140 encompasses any internal or external network, networks, sub-network, or combination thereof operable to facilitate communications between various computing components inside and outside the illustrated system 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

The BOE repository 180 represents an application, set of applications, software, software modules, or combination of software and hardware that interface with the system database 182 and the file repository 184. The BOE repository 180 may receive requests from the analytic system 102 for raw analytical data through a corba layer and retrieve the raw analytical data from the system database 182 and/or the file repository 184. The BOE repository 180 may send the raw analytic data to the analytic system 102 in response to the request.

The databases 190 represents an application, set of applications, software, software modules, or combination of software and hardware that stores raw analytical data. The databases 190 may be implemented by any database technologies. For example, the databases 190 may be an in-memory database (e.g., SAP's HANA), a relational database, or any other databases. In some implementations, the databases 190 may receive requests from the analytic system 102 and send the requested raw analytic data in response.

While portions of the software elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

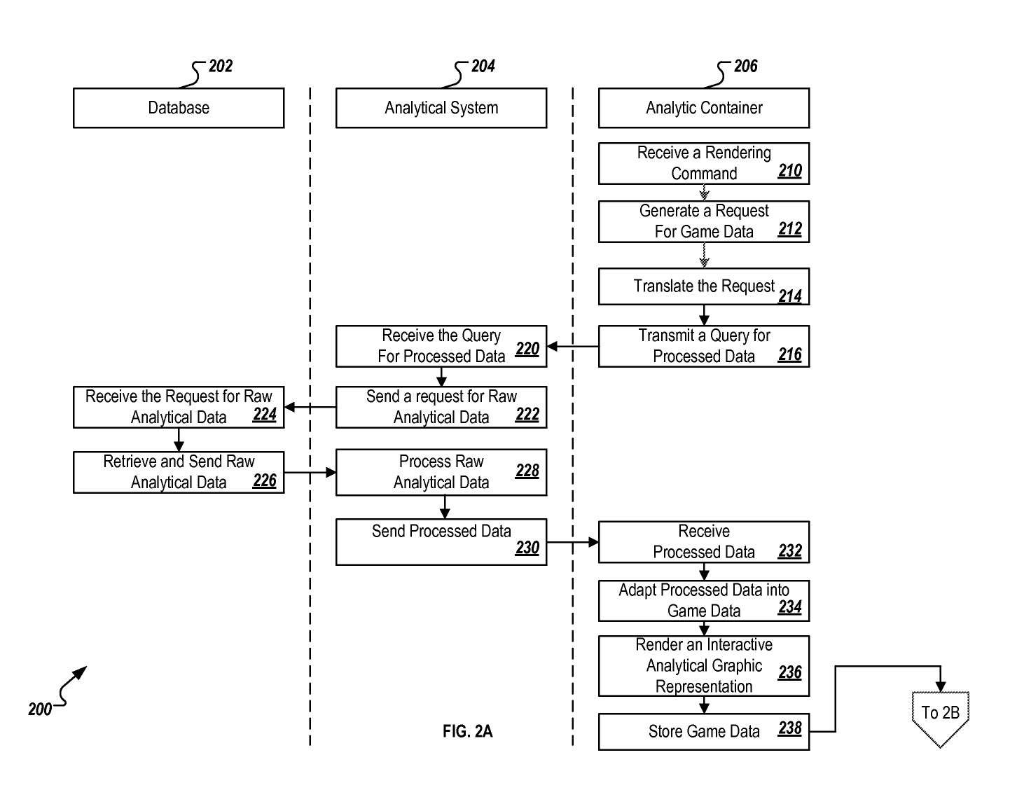

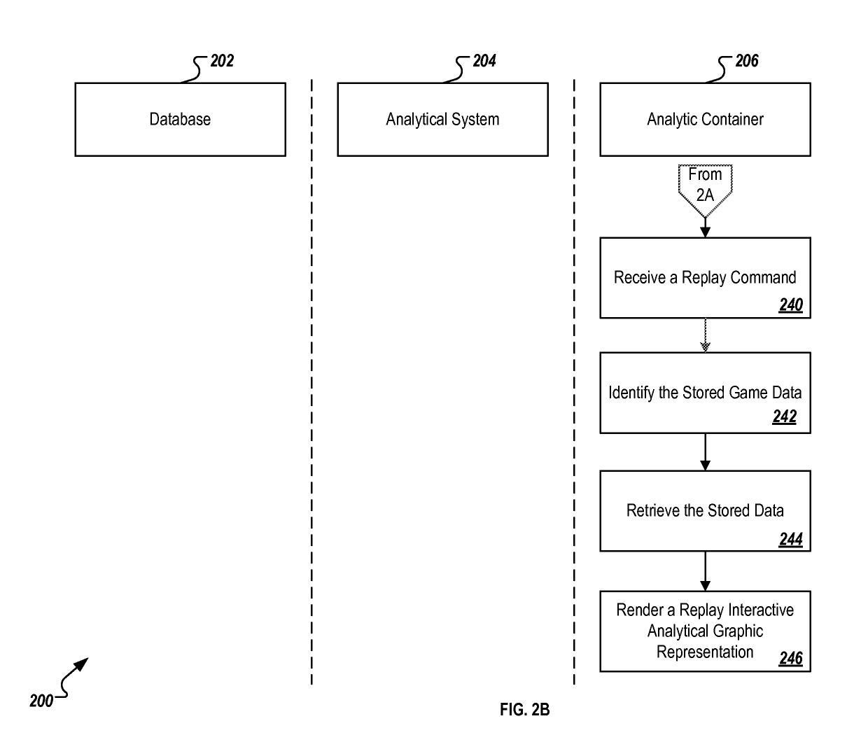

FIGS. 2A and 2B are a combined swim-lane diagram 200 illustrating example operations related to actions for rendering interactive analytical graphic representations using a game engine. The database 202, the analytical system 204, and the analytic container 206 may be associated with one or more devices in this example, and the one or more devices may perform the described operations.

At 210, the analytic container 206 can receive a rendering command to initiate a rendering service for a business process. In some cases, the analytic container 206 is located at a client. In some implementations, the rendering services may be one of the services provided to a user through a service bus. The service bus may be a tool that provides a collection of analytic services to the user. Service Application Program Interface Application Programming Interfaces (APIs) may be used to provide each service offered in the service bus. In some cases, the service APIs are coarse grained, which may enable the users to complete most operations in one roundtrip. For example, a coarse-grained system may have less method calls than a fine-grained system. Coarse-grained methods may be fewer and do more work than the broken-down fine-grained versions. Since the servers might be running on different machines, it becomes expensive and time consuming if the system has fine-grained APIs. In some cases, the service APIs can be similar to REST-style calls, where one call can perform multiple jobs to handle data and resource. The rendering service may support both stateless and stateful rendering operations. In some cases, the underlying analytic data to be analyzed may have a state dependency between them. For example, the underlying analytic data may represent a security operation which has stateful security context. In such a case, the rendering service may perform a stateful rendering operation, where the interactive analytical graphic representation to be rendered may have a state dependency with another interactive analytical graphic representation. In some cases, the underlying analytic data have no state dependency among them and the rendering service may perform a stateless rendering operation.

At 212, the analytic container 206 can generate a request for a set of game data related to the business process. In some cases, the request may be generated by a user who performs a business analysis. In some cases, the request may also be generated by an application that performs a business analysis. As described above, game data are data that can be used by a game engine to render the requested interactive analytical graphic representation.

At 214, the analytic container 206 can translate the request for a set of game data to an analytic query for a set of processed data related to the business process. As described above, the set of processed data is a set of data that are processed by the analytical system 204 based on raw analytical data. In general, the set of processed data can be accessed from the analytical system 204 using a query operation. The query operation is initiated by a request to the analytical system 204 in the format of an analytic query.

At 216, the analytic container 206 can transmit the analytic query to the analytic system 204. In some implementations, the analytic system 204 can be located at a server that is connected with the analytic container 206 through the Internet or any other data networks. In some cases, the analytic query may be transmitted over the Internet using HTTP protocol.

At 220, the analytical system 204 can receive the query for processed data. In some cases, the analytical system 204 may have processed the raw analytic data related to the business process and stored the processed data. In such a case, the analytical system 204 can retrieve the processed data and send the processed data to the analytic container 206 at 230. In some cases, the analytical system 204 may generate processed data in response to the query. In such a case, at 222, the analytical system 204 can send a request for a set of raw analytical data related to the business process to the database 202. In some cases, database 202 may be a BOE repository that stores raw analytical data. In such a case, the request for raw analytical data may be communicated over a corba layer. In some cases, the database 202 may be any other databases that store raw analytical data.

At 224, the database 202 can receive the request for raw analytical data. At 226, the database 202 can retrieve and send the requested raw analytical data to the analytical system. In some cases, database 202 may be a BOE repository. In such a case, the raw analytical data may be sent over a corba layer.

At 228, the analytical system 204 can generate a set of processed data. The set of processed data is generated by processing the set of received raw analytical data. In some implementations, the set of processed data is stored in a processed data format that is used by the analytical system 204. At 230, the analytical system 204 can send the set of processed data to the analytic container 206.

At 232, the analytic container 206 can receive the set of processed data. At 234, the analytic container 206 can adapt the set of processed data into a set of game data. In some implementations, the adaptation is performed by an analytical adapter in the analytic container 206. In some implementations, the set of game data is stored in a game data format. The game data format may be different (i.e., in a second format) than the processed data format. Converting the data from processed data format to game data format in the analytic container 206 can shield the analytic system 204 from the rendering operations of the business process. Therefore, the analytic system 204 may be a traditional business analytical application that does not include the capability to directly interact with a game engine. This approach minimizes complexities in building and maintaining the analytic system 204.

At 236, the analytic container 206 can render an interactive analytical graphic representation based on the set of game data. In some implementations, the rendering operation is performed by a game engine inside the analytic container 206. In some implementations, the interactive analytical graphic representation may be rendered at an analytical client. The analytical client may be a web browser, a mobile application, or any other client software at client site that presents interactive analytical graphic representations. In some implementations, the game engine may be built by using Web Graphics Library (WebGL). This approach minimizes the requirement for mounting any supplementary software and may bring hardware-augmented 3-Dimensional images to the browser. In some implementations, the game engine also provides stop, replay, sound, crash detection, streaming, memory management, or any other functionalities for the rendering operations.

At 238, the analytic container 206 can store the set of game data. In some cases, the analytic container 206 may store the game data locally at the analytical container 206. Alternatively or in combination, the analytic container 206 may store the game data in a web software, or in a memory storage at a remote location. In some implementations, the analytic container 206 may parse the set of game data and use a filter to filter the set of game data into a subset of game data that is useful for replay or future analytics. In some cases, the analytic container 206 may store the subset of game data instead of the entire set of game data. In some implementations, the parsing logic and the filtering operations may be shielded away from the user and may be performed automatically by the analytic container 206. In some implementations, the user may provide input parameters for the filtering operations.

At 240, the analytic container 206 can receive a replay command. The replay command may be generated by a user to replay an interactive analytical graphic representation of a business process. At 242, the analytic container 206 can identify a set of game data previously stored at 238. In some implementations, the set of game data is stored according to its associated interactive analytical graphic representation. In such a case, the analytic container 206 may identify the stored set of game data based on the interactive analytical graphic representation to be replayed by the replay command. In some implementations, the set of game data is stored according to its associated business process. In such a case, the analytic container 206 may identify the stored set of game data based on the business process to be analyzed by the replay command. At 244, the analytic container 206 can retrieve the stored set of game data.

At 246, the analytic container 206 can render a replay interactive analytical graphic representation based on the stored set of game data. The replay interactive analytical graphic representation is an interactive analytic graphic representation of a business process that has previously been rendered. In some implementations, the rendering operation is performed by a game engine inside the analytic container 206. In some implementations, the replay interactive analytical graphic representation may be rendered at an analytical client. The analytical client may be a web browser, a mobile application, or any other client software at client site that presents replay interactive analytical graphic representations.

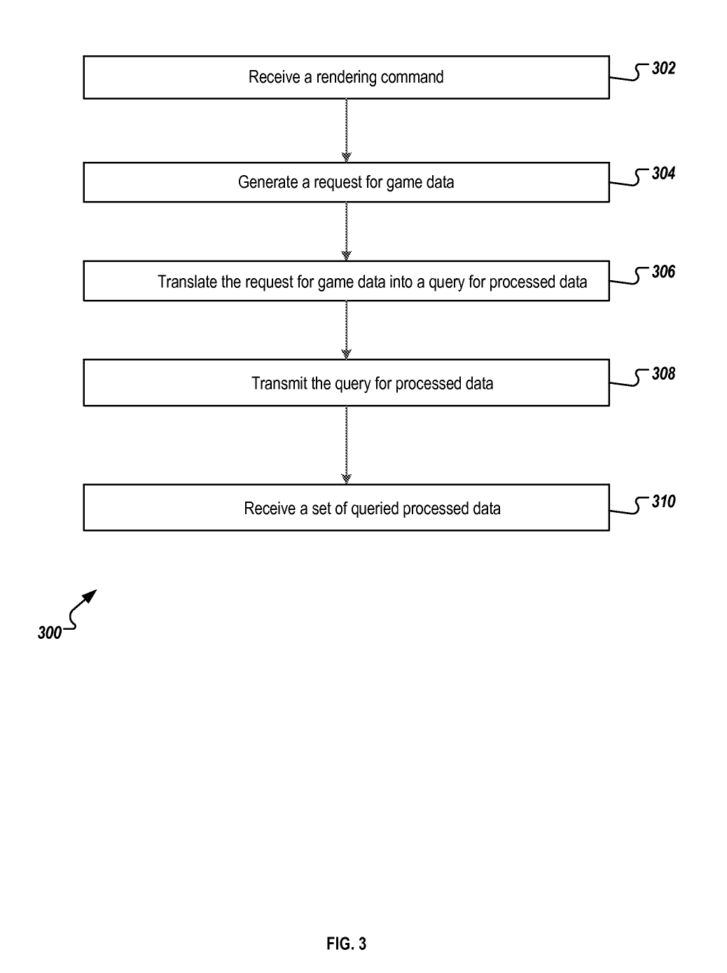

FIG. 3 is a flowchart of an example operation 300 related to translating a request for game data into a query for processed data. For clarity of presentation, the description that follows generally describes operation 300 in the context of the system 100 illustrated in FIG. 1. However, it will be understood that operation 300 may be performed, for example, by any other suitable system, environment, software, and hardware, or a combination of systems, environments, software, and hardware as appropriate.

At 302, a rendering command is received. The rendering command may be generated by a user and received by an analytical container. In some cases, the rendering command is related to a business process to be analyzed. At 304, a request for game data is generated. In some cases, the request for game data is formatted according to a protocol used by a game engine in the analytical container. At 306, the request for game data is translated to a query for processed data. In some cases, the query for processed data is formatted according to a protocol that is used by an analytical application to request processed data. The analytical application generates processed data based on raw analytical data related to the business process to be analyzed. At 308, the query for processed data is transmitted. In some cases, the query is transmitted from the analytical container to the analytical application over an HTTP protocol. At 310, the queried processed data is received. In some cases, the queried processed data is transmitted by the analytical application to the analytical container over an HTTP protocol.

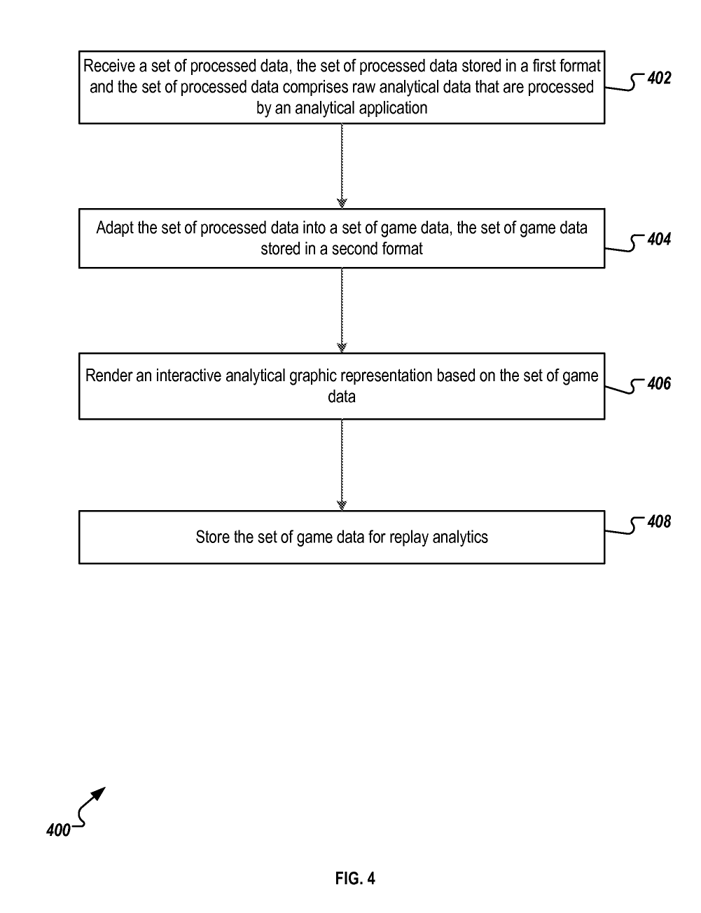

FIG. 4 is a flowchart of an example operation 400 related to rendering an interactive analytical graphic representation. While example operations are shown, the actual operations may vary based on particular implementations of the system and operations.

At 402, a set of processed data is received. In some cases, the set of process data is transmitted from the analytical application to the analytical container. In some implementations, the analytical application may process raw analytical data and generate processed data. The analytical application may store the set of processed data in a first format.

At 404, the set of processed data is adapted into a set of game data. The set of game data is stored in a second format. In some cases, the second format is different than the first format. In some implementations, the adaption is performed by the analytical container.

At 406, an interactive analytical graphic representation is rendered. The interactive analytical graphic representation is based on the set of game data. In some implementations, the interactive analytical graphic representation is a 2-Dimensional image or a 3-Dimensional image. In some implementations, the rendering is performed by a game engine inside the analytical container. In some implementations, the game engine may be built using WebGL.

At 408, the set of game data is stored for replay analytics. In some implementations, the set of game data is stored at the analytical container. In some implementations, the set of game data is filtered to generate a subset of game data, and the subset of game data is stored for replay analytics.

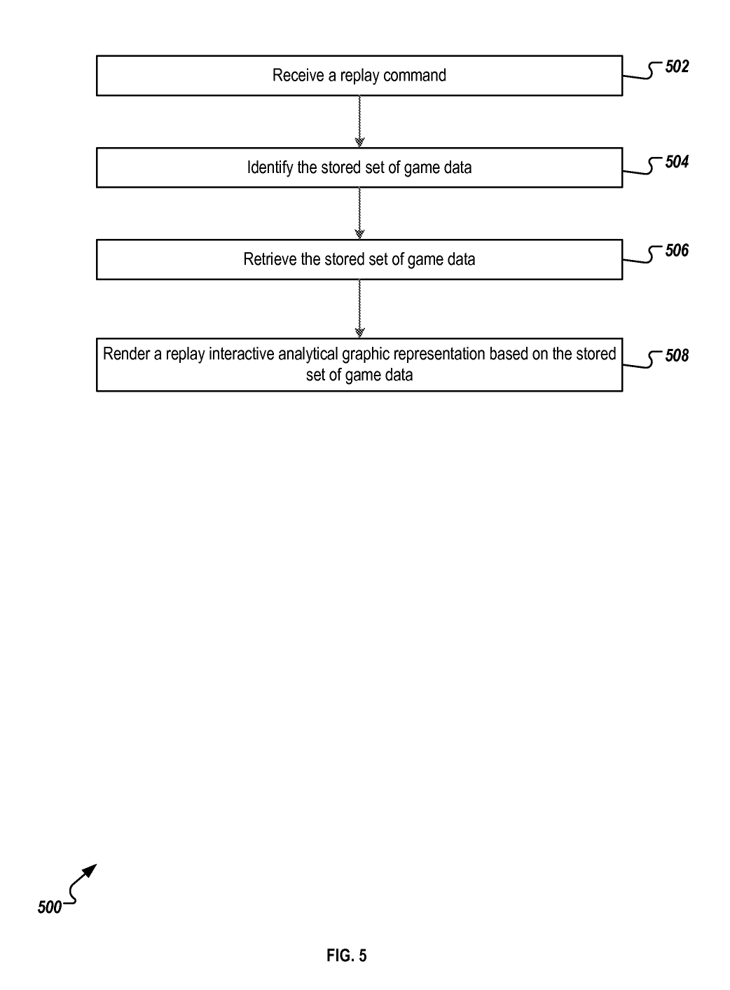

FIG. 5 is a flowchart of an example operation 500 related to replaying an interactive analytical graphic representation. For clarity of presentation, the description that follows generally describes operation 500 in the context of the system 100 illustrated in FIG. 1. However, it will be understood that operation 500 may be performed, for example, by any other suitable system, environment, software, and hardware, or a combination of systems, environments, software, and hardware as appropriate.

At 502, a replay command is received. The replay command requests a replay of an interactive analytic graphic representation. At 504, a stored set of game data is identified in response to receiving the replay command. In some implementations, the stored set of game data may be identified based on the interactive analytic graphic representation associated with the replay command. At 506, the stored set of game data is retrieved. At 508, a replay interactive analytical graphic representation is rendered. The replay interactive analytical graphic representation is based on the stored set of game data.

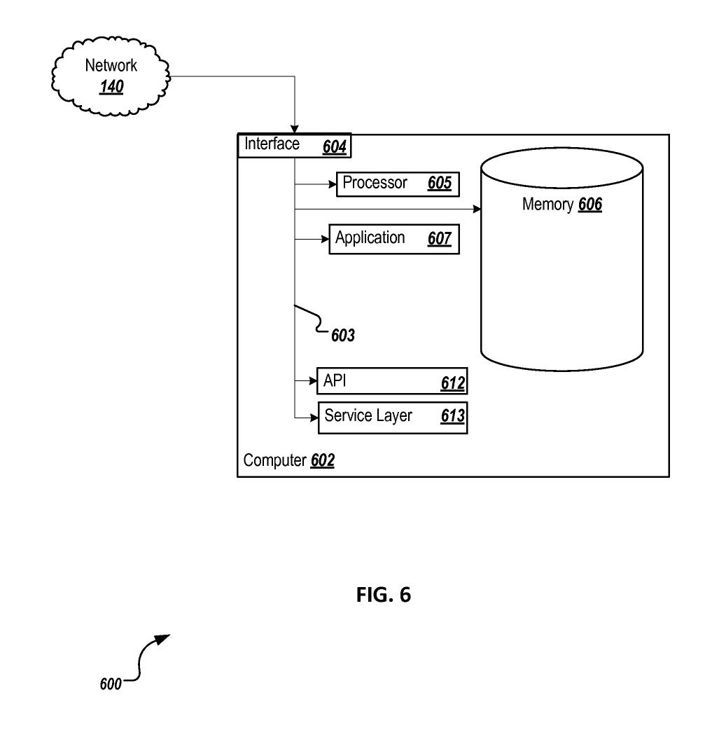

FIG. 6 is a block diagram 600 of an exemplary computer used to render interactive analytical graphic representations with a game engine according to an implementation. The illustrated computer 602 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 602 may comprise a computer that includes an input device, such as a keypad, keyboard, touch screen, or other device that can accept user information, and an output device that conveys information associated with the operation of the computer 602, including digital data, visual and/or audio information, or a GUI.

The computer 602 can serve as a client (e.g., which includes the analytic client 150), network component, a server, a database or other persistency, and/or any other component of the example system 100 for rendering interactive analytical graphic representations using a game engine. The illustrated computer 602 is communicably coupled with a network 630 (e.g., the network 140). In some implementations, one or more components of the computer 602 may be configured to operate within a cloud-computing-based environment.

At a high level, the computer 602 is an electronic computing device operable to receive, transmit, process, store, or manage data and information associated with the example system 100 for rendering interactive analytical graphic representations using a game engine. According to some implementations, the computer 602 may also include or be communicably coupled with an application server, e-mail server, web server, caching server, streaming data server, business intelligence (BI) server, and/or other server.

The computer 602 can receive requests over network 630 from a client application (e.g., executing on another computer 602) and respond to the received requests by processing the said requests in an appropriate software application. In addition, requests may also be sent to the computer 602 from internal users (e.g., from a command console or by another appropriate access method), external or third parties, other automated applications, as well as any other appropriate entities, individuals, systems, or computers.

Each of the components of the computer 602 can communicate using a system bus 603. In some implementations, any and/or all the components of the computer 602, both hardware and/or software, may interface with each other and/or the interface 604 over the system bus 603 using an application programming interface (API) 612 and/or a service layer 613. The API 612 may include specifications for routines, data structures, and object classes. The API 612 may be either computer language-independent or -dependent and refer to a complete interface, a single function, or even a set of APIs. The service layer 613 provides software services to the computer 602 and/or the example system 100 for rendering interactive analytical graphic representations using a game engine. The functionality of the computer 602 may be accessible for all service consumers using this service layer. Software services, such as those provided by the service layer 613, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 and/or the service layer 613 as stand-alone components in relation to other components of the computer 602 and/or example system 100 for rendering interactive analytical graphic representations using a game engine. Moreover, any or all parts of the API 612 and/or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602 and/or example system 100 for rendering interactive analytical graphic representations using a game engine. The interface 604 is used by the computer 602 for communicating with other systems in a distributed environment—including within the example system 100 for rendering interactive analytical graphic representations using a game engine—connected to the network 630 (whether illustrated or not). Generally, the interface 604 comprises logic encoded in software and/or hardware in a suitable combination and operable to communicate with the network 630. More specifically, the interface 604 may comprise software supporting one or more communication protocols associated with communications such that the network 630 or interface's hardware is operable to communicate physical signals within and outside of the illustrated example system 100 for rendering interactive analytical graphic representations using a game engine.

The computer 602 includes a processor 605. Although illustrated as a single processor 605 in FIG. 6, two or more processors may be used according to particular needs, desires, or particular implementations of the computer 602 and/or the example system 100 for rendering interactive analytical graphic representations using a game engine. Generally, the processor 605 executes instructions and manipulates data to perform the operations of the computer 602. Specifically, the processor 605 executes the functionality required for rendering interactive analytical graphic representations using a game engine.

The computer 602 also includes a memory 606 that holds data for the computer 602 and/or other components of the example system 100 for rendering interactive analytical graphic representations using a game engine. Although illustrated as a single memory 606 in FIG. 6, two or more memories may be used according to particular needs, desires, or particular implementations of the computer 602 and/or the example system 100 for rendering interactive analytical graphic representations using a game engine. While memory 606 is illustrated as an integral component of the computer 602, in alternative implementations, memory 606 can be external to the computer 602 and/or the example system 100 for rendering interactive analytical graphic representations using a game engine.

The application 607 is an algorithmic software engine providing functionality according to particular needs, desires, or particular implementations of the computer 602 and/or the example system 100 for rendering interactive analytical graphic representations using a game engine, particularly with respect to functionality required for rendering interactive analytical graphic representations using a game engine. For example, application 607 can serve as one or more components/applications described in FIGS. 1-6. Further, although illustrated as a single application 607, the application 607 may be implemented as multiple applications 607 on the computer 602. In addition, although illustrated as integral to the computer 602, in alternative implementations, the application 607 can be external to the computer 602 and/or the example system 100 for rendering interactive analytical graphic representations using a game engine.

There may be any number of computers 602 associated with, or external to, the example system 100 for rendering interactive analytical graphic representations using a game engine and communicating over network 630. Further, the term “client,” “user,” and other appropriate terminology may be used interchangeably as appropriate without departing from the scope of this disclosure. Moreover, this disclosure contemplates that many users may use one computer 602, or that one user may use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus,” “computer,” or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example, LINUX, UNIX, WINDOWS, MAC OS, ANDROID, IOS, or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic disks, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media, and memory devices, including by way of example, semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user, and a keyboard and a pointing device, e.g., a mouse, trackball, or trackpad, by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language-independent or -dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

The preceding figures and accompanying description illustrate example systems, processes, and computer-implementable techniques. While the illustrated systems and processes contemplate using, implementing, or executing any suitable technique for performing these and other tasks, it will be understood that these systems and processes are for illustration purposes only and that the described or similar techniques may be performed at any appropriate time, including concurrently, individually, or in combination, or performed by alternative components or systems. In addition, many of the operations in these processes may take place simultaneously, concurrently, and/or in different orders than as shown. Moreover, the illustrated systems may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
receiving, from an analytical system, a set of processed data, wherein the set of processed data is stored in a first format, wherein the set of processed data comprises raw analytical data that are processed by an analytical application;
adapting the set of processed data into a set of game data, wherein the set of game data is stored in a second format;
rendering an interactive analytical graphic representation based on the set of game data; and
storing the set of game data for replay analytics.

2. The method of claim 1, further comprising:
receiving a replay command;
identifying, in response to receiving the replay command, the stored set of game data;
retrieving the stored set of game data; and
rendering a replay interactive analytical graphic representation based on the stored set of game data.

3. The method of claim 1, further comprising:
receiving a rendering command;
generating a request for game data;
translating the request for game data into a query for processed data;
transmitting, to the analytical system, the query for processed data; and
receiving, in response to the query, a set of queried processed data.

4. The method of claim 1, wherein the first interactive analytical graphic representation is a 3-Dimensional (3D) or a 2-Dimensional (2D) image.

5. The method of claim 1, wherein the raw analytical data comprises business analytical data.

6. The method of claim 1, wherein the interactive analytical graphic representation is presented at an analytical client, wherein the analytical client presents the interactive analytical graphic representation in a web browser.

7. The method of claim 1, wherein the rendering is performed by a game engine that uses Web Graphics Library (WebGL).

8. The method of claim 1, wherein the rendering is performed by a game engine in an analytical container.

9. A system, comprising:
a memory; and
at least one hardware processor interoperably coupled with the memory and configured to:
receive, from an analytical system, a set of processed data, wherein the set of processed data is stored in a first format, wherein the set of processed data comprises raw analytical data that are processed by an analytical application;
adapt the set of processed data into a set of game data, wherein the set of game data is stored in a second format;
render an interactive analytical graphic representation based on the set of game data; and
store the set of game data for replay analytics.

10. The system of claim 9, wherein the at least one hardware processor is further configured to:
receive a replay command;
identify, in response to receiving the replay command, the stored set of game data;
retrieve the stored set of game data; and
render a replay interactive analytical graphic representation based on the stored set of game data.

11. The system of claim 9, wherein the at least one hardware processor is further configured to:
receive a rendering command;
generate a request for game data;
translate the request for game data into a query for processed data;
transmit to the analytical system, the query for processed data; and
receive, in response to the query, a set of queried processed data.

12. The system of claim 9, wherein the first interactive analytical graphic representation is a 3-Dimensional (3D) or a 2-Dimensional (2D) image.

13. The system of claim 9, wherein the raw analytical data comprises business analytical data.

14. The system of claim 9, wherein the interactive analytical graphic representation is presented at an analytical client, wherein the analytical client presents the interactive analytical graphic representation in a web browser.

15. The system of claim 9, wherein the rendering is performed by a game engine that uses Web Graphics Library (WebGL).

16. The system of claim 9, wherein the rendering is performed by a game engine in an analytical container.

17. A non-transitory, computer-readable medium storing computer-readable instructions executable by a computer and configured to:
receive, from an analytical system, a set of processed data, wherein the set of processed data is stored in a first format, wherein the set of processed data comprises raw analytical data that are processed by an analytical application;
adapt the set of processed data into a set of game data, wherein the set of game data is stored in a second format;
render an interactive analytical graphic representation based on the set of game data; and
store the set of game data for replay analytics.

18. The non-transitory, computer-readable medium of claim 17, wherein the instructions are further configured to:
receive a replay command;
identify, in response to receiving the replay command, the stored set of game data;
retrieve the stored set of game data; and
render a replay interactive analytical graphic representation based on the stored set of game data.

19. The non-transitory, computer-readable medium of claim 17, wherein the instructions are further configured to:
receive a rendering command;
generate a request for game data;
translate the request for game data into a query for processed data;
transmit to the analytical system, the query for processed data; and
receive, in response to the query, a set of queried processed data.

20. The non-transitory, computer-readable medium of claim 17, wherein the first interactive analytical graphic representation is a 3-Dimensional (3D) or a 2-Dimensional (2D) image.
